(19) United States
(12) Patent Application Publication
(10) Pub. No.: US 2009/0128629 A1
(43) Pub. Date: May 21, 2009

(54) OPTICAL MODULE FOR AN ASSISTANCE SYSTEM

(75) Inventors: Peter Egbert, Engelskirchen (DE); Steffen Goermer, Wuppertal (DE); Ing Su-Birm Park, Aldenhoven (DE)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/273,578

(22) Filed: Nov. 19, 2008

(30) Foreign Application Priority Data
Nov. 21, 2007 (EP) 07022598.2

(51) Int. Cl. G06K 9/00; H04N 7/18

(52) U.S. Cl. 348/148; 382/103

(57) ABSTRACT

The invention concerns an optical module for an assistance system covering an ambient region of a vehicle, having a camera arranged in the region of an inner side of a pane of glass, in particular a windscreen, of the vehicle and directed into the ambient region of the vehicle, with an objective through which a distant region can be imaged in sharp focus on a first section of a sensor surface of the camera, and having an optical assembly which is arranged in the field of vision of the camera and by which a close region covering a detection region of the pane can be imaged in sharp focus on a second section of the sensor surface of the camera. The invention further concerns a method for controlling a wiping interval of a windscreen wiper, in particular of a motor vehicle, by means of such an optical module.

### TECHNICAL FIELD

The invention concerns an optical module for an assistance system covering an ambient region of a vehicle, having a camera arranged in the region of an inner side of a pane of glass, in particular a windscreen, of the vehicle and directed into the ambient region of the vehicle, with an objective through which a distant region can be imaged in sharp focus on a first section of a sensor surface of the camera.

### BACKGROUND OF THE INVENTION

An optical module of this kind is basically well known and is used for example in a night vision assistance system or in a system for lane detection, lane change warning, obstacle warning, pre-crash detection, automatic speed adaptation, road sign detection or in a traffic jam assistance system.

It is further known that the optical module can be additionally equipped with a rain sensor function. For this purpose, for example light is coupled into the pane of glass in such a way that it is reflected at least approximately completely on the outer side of the pane when the outer side of the pane is dry, and at least partially coupled out of the outer side of the pane on the latter side when drops of water are located on the latter side. By the camera the intensity of the light reflected on the outer side of the pane is detected, and from the detected light intensity the degree of wetting of the pane with water and hence the rain intensity are ascertained.

### SUMMARY OF THE INVENTION

It is the object of the invention to provide an optical module of the kind mentioned hereinbefore with an improved rain sensor function.

The optical module according to the invention comprises a camera arranged in the region of an inner side of a pane of glass of a vehicle, in particular a windscreen, also referred to herein as a windshield. The camera is directed into the ambient region of the vehicle, with an objective through which a distant region can be imaged in sharp focus on a first section of a sensor surface of the camera. Distant region in this context means a region which extends from a distance of several metres from the camera into infinity. The objective is in other words focused to infinity.

Furthermore, the optical module according to the invention comprises an optical assembly which is arranged in the field of vision of the camera and by which a close region covering a detection region of the pane can be imaged in sharp focus on a second section of the sensor surface of the camera. Close region in this context means a region which extends by possibly several centimetres in front of and behind the pane of glass. The optical assembly in other words therefore causes additional focusing of the camera on a part of the pane, namely the so-called detection region, which could not be reached by the objective on its own due to the depth of field of the objective focused to infinity.

According to the invention, it is therefore possible by means of a single camera to observe not only a distant region of the vehicle environment, but at the same time also part of the pane. In the process, the part of the image which is projected by the optical assembly has so low a depth of field that only those objects which are not more than a few centimetres in front of or behind the pane are projected sharply by the optical assembly. In this way, objects located on the pane, in particular drops of water, ice crystals or snowflakes, can be detected, while objects further away are not shown in focus and so cannot falsify the result of detection. The result of this object detection can therefore be used for particularly accurate and reliable determination of the rain or snowfall intensity, for example in order to achieve operation of a windscreen wiper which is as efficient as possible by suitable adjustment of a wiping interval.

The second section of the sensor surface used for observation of the detection region of the pane is preferably formed by a section of the sensor surface which is not used for the core function, e.g. lane or road sign detection or night vision assistance. The second section can be for example a lower section of the sensor surface on which e.g. the bonnet of the vehicle would be imaged if there were no optical assembly.

Advantageous embodiments of the invention can be found in the subsidiary claims, the description and the drawings.

According to an embodiment, the optical assembly comprises at least one lens arranged between the pane and the camera objective. By the lens which preferably comprises a converging lens, focusing of the camera onto the close region is achieved, so that the detection region of the pane is located within range of the depth of field of the camera.

To achieve as compact as possible a design of the optical module, the optical assembly preferably comprises a mirror which guides light emerging from the detection region of the pane through the lens and into the camera.

To prevent the core function of the optical module from being impaired by light deflected by the mirror, the optical assembly can further comprise a screen which prevents light deflected by the mirror from impinging on the first section of the sensor surface of the camera.

As already mentioned, the determination of rain intensity which is made possible by the optical module according to the invention is based on detection of objects on the pane. For this, in daylight typically no illumination of the detection region of the pane by a light source provided specially for this purpose is needed, as the daylight is normally sufficient to make relevant objects such as e.g. raindrops visible on the pane. Nevertheless, advantageously, a light source is provided for illumination of the detection region of the pane in order to enable detection of objects located on the pane even at night time.

The light source may comprise at least one light-emitting diode which preferably emits in the infrared wavelength range, hence not visible to the human eye, in order for example not to irritate other road users.

To ensure that light reflected on an object located on the pane passes into the camera, the light source advantageously radiates in a preferential direction so that the light of the light source which is coupled into the pane impinges on the outer side of the pane at an angle not equal to 90°. The preferential direction may for example form an angle within the range from approximately 10° to 30° with the inner side of the pane.

A particularly compact design is obtained if the light source is arranged on a side of the mirror facing away from the camera.

To prevent light from the light source from passing into the camera directly, i.e. therefore without passing through the pane, and so impairing object detection, the mirror is advantageously at least substantially impermeable to the light of the light source if the light source is arranged on a side of the mirror facing away from the camera. But with a different arrangement of the light source, use of a mirror which partially transmits the light of the light source is also conceivable.

According to a further embodiment, the camera is coupled to an image evaluation unit by which an object located on the pane can be detected in an image recorded by the second section of the sensor surface. Object detection preferably takes place by edge extraction, i.e. therefore using an algorithm which calculates an edge image, e.g. using the Sobel operator.

The image evaluation unit can be coupled to a windscreen wiper control system which adjusts a wiping interval of a windscreen wiper as a function of the result of object detection. For instance, upon detection of a larger number of objects, in particular raindrops, in the detection region of the pane, a shorter wiping interval can be set, i.e. a shorter interval between two wiping operations, whereas upon detection of a smaller number of objects a longer wiping interval can be set, i.e. a longer interval between two wiping operations.

A further subject of the invention is moreover a method for controlling a wiping interval of a windscreen wiper, in particular of a motor vehicle, by means of an optical module of the kind described above, in which object detection is carried out in an image recorded by the second section of the sensor surface, and the wiping interval of the windscreen wiper is controlled as a function of the result of object detection.

As already mentioned, object detection is preferably carried out by performing edge extraction on the recorded image. In this case an extracted edge of a detected object can be segmented by means of an adaptive threshold value, as a result of which image artefacts for example caused by noise can be eliminated.

A particularly simple and yet reliable way of determining the rain intensity is achieved by the fact that the picture elements which represent a segmented edge of a detected object or the segmented edges of several detected objects are added up and the rain intensity is determined with the aid of the sum of the picture elements.

It is moreover advantageous to evaluate an image which is recorded immediately after passage of a wiper blade through the detection region of the pane, and to classify an object detected therein as a disturbing object. The disturbing object may be for example dirt which is on the pane, or dust which is on the mirror or the lens, in other words therefore an object which, unlike a raindrop, at least cannot be removed by the windscreen wiper in a single wiping operation. The disturbing object is preferably ignored in object detection in a subsequently recorded image, and so to a certain extent it is counted out or deducted from an added-up sum of picture elements. In this way the knowledge of a disturbing object allows even more accurate determination of the rain intensity.

A further advantageous embodiment of the method according to the invention lies in that an image recorded by the second section of the sensor surface is divided into several partial regions, and in a partial region which shows significantly higher brightness than the other partial regions no object detection is carried out. In this way an image artefact produced for example by street lighting can be prevented from falsifying the result of object detection and so ultimately impairing determination of the rain intensity.

### BRIEF DESCRIPTION OF THE DRAWINGS

Below, the invention is described purely as an example with the aid of an advantageous embodiment with reference to the attached drawings. They show:

FIG. 1 is a schematic view of an optical module according to the invention; and

FIG. 2 is a schematic view of an image recorded by a camera of the optical module of FIG. 1.

### DESCRIPTION OF THE PREFERRED EMBODIMENT

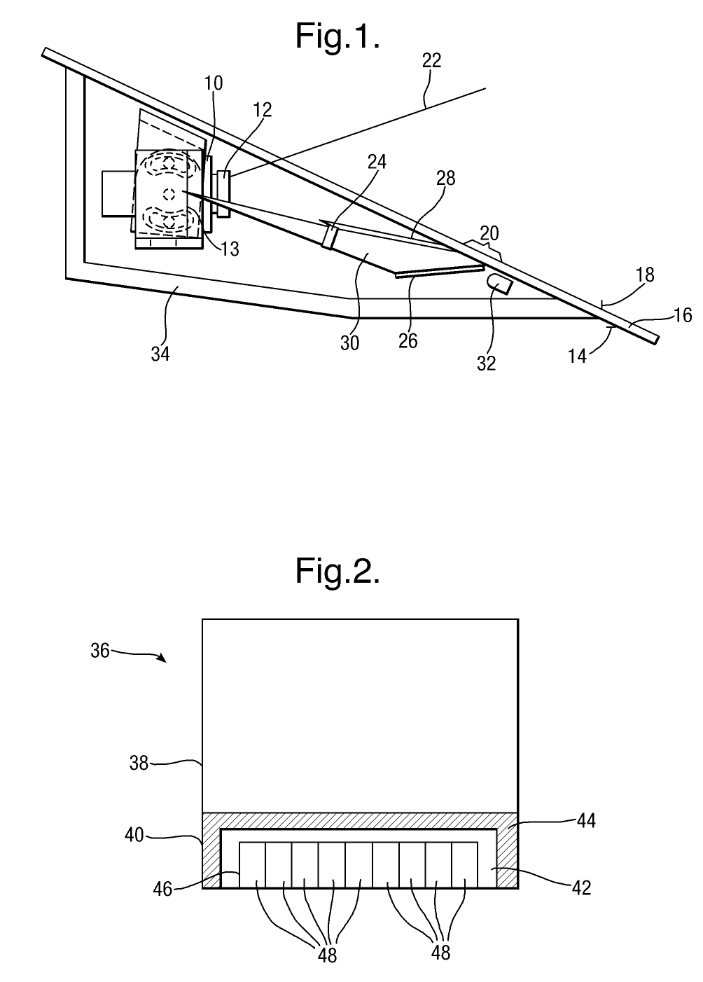

The optical module shown in FIG. 1 is the optical module of an assistance system which covers an ambient region of a motor vehicle, not shown, and of which the core function consists for example of the detection of a lane, an obstacle located in the path of the vehicle and/or a road sign, and/or serves as a night vision assistant, as a traffic jam assistant and/or as a parking aid.

The optical module comprises a camera 10 having an objective 12 and a sensor surface 13 defined by a flat-panel sensor, e.g. a CMOS flat-panel sensor. The camera 10 is a so-called greyscale camera or a colour camera with no infrared filter, i.e. the flat-panel sensor detects both visible light and light in the infrared wavelength range.

The camera 10 is arranged in the region of the inner side 14 of a windscreen 16 of the vehicle, also referred to herein as a windshield. Camera 10 is directed into an ambient region of the vehicle located in front of the vehicle, seen in the direction of travel. In other words, the camera looks through the windscreen 16 to the outside (to the right in FIG. 1).

The objective 12 is constructed in such a way that objects located in a distant region, i.e. therefore objects located at a distance from several metres to a few kilometres from the camera 10, are imaged in sharp focus on the sensor surface 13. The objective 12 is in other words focused to infinity. Due to the limited depth-of-field range of the objective 12 on the one hand and the comparatively short distance between the camera 10 and the windscreen 16 on the other hand, objects located in the region of the windscreen 16 and in particular on the outer side 18 of the windscreen 16 cannot be imaged in sharp focus without additional aids on the sensor surface 13 of the camera 10.

To overcome this disadvantage, the optical module comprises an optical assembly which is arranged in the field of vision of the camera 10 and by which a close region encompassing a detection region 20 of the windscreen 16 can be imaged in sharp focus on the sensor surface 13 of the camera 10. In this case the optical assembly is designed in such a way as to create, in combination with the objective 12, a depth-of-field range which extends a few centimetres in front of and behind the windscreen 16, i.e. starting from the windscreen, a few centimetres inwards and outwards.

The optical assembly comprises a lens 24 arranged between the objective 12 and the windscreen 16 in a lower region of the field of vision 22 of the camera 10, and a mirror 26 located below the lens 24 and adjoining the inner side 14 of the windscreen 16. Above the lens 24 is arranged a screen 28 extending from the lens 24 to the inner side of the windscreen 16.

The screen 28 and the mirror 26 define the detection region 20 of the windscreen 16, so that this region has an area of several square centimetres. In this case the mirror 26 forms an angle with the inner side of the windscreen 16 so as to guide light 30 emerging from the windscreen 16 through the lens 24 into the camera 10, while the screen 28 prevents light reflected by the mirror from passing directly to the camera 10, i.e. past the lens 24.

If it is bright enough in the environment of the vehicle to make objects located on the windscreen visible, the light 30 is ambient light, typically daylight.

In order that objects located on the windscreen 16 can also be detected in adverse light conditions, in particular at night, the optical module comprises at least one infrared light-emitting diode 32 which is arranged on the side of the mirror 26 facing away from the camera 10. In order that light emitted by the light-emitting diode 32 cannot enter the camera 10 unhindered and adversely affect image recording, the mirror 26 does not transmit the light of the light-emitting diode 32.

The light-emitting diode 32 is oriented in such a way that its preferential direction of emission forms with the inner side 14 of the windscreen 16 an angle within the range from approximately 10° to 30°. As a result, the light of the light-emitting diode 32 coupled into the windscreen 16 impinges on the outer side 18 of the windscreen 16 at an angle which ensures that at least some of the light of the light-emitting diode 32 is coupled out of the windscreen 16 and reflected back into the windscreen 16 by an object located on the windscreen 16, in order then to be deflected by the mirror 26 and guided through the lens 24 into the camera 10.

By a cover 34, the optical module is shielded from the interior of the vehicle. In particular, the cover 34 prevents disturbing light reflections from passing out of the vehicle interior into the camera 10 and adversely affecting the result of detection.

As can be seen from FIG. 2, an image 36 recorded by the camera 10 consists of two sections, namely a larger first section, the so-called main section 38, and a smaller second section, the so-called auxiliary section 40.

The main section 38 shows the projection of the distant region on the sensor surface 13 and is used for the core function of the optical module. The auxiliary section 40 is an image region which is not used for the core function, for example because it would show only the bonnet of the vehicle in the absence of the optical assembly.

As FIG. 1 shows, the optical assembly, i.e. the combination of lens 24, mirror 26, screen 28 and LED 32, is arranged in such a way that the detection region 20 of the windscreen 16 is imaged in the auxiliary section 40 of the image 36. The projection of the detection region 20 is marked with reference number 42 in FIG. 2. The portion 44 of the auxiliary section 40 surrounding the projection 42 of the detection region 20 is substantially black and results from shading by the screen 28.

The camera 10 is connected to an image evaluation unit, not shown, for evaluation of the images recorded by the camera 10. Evaluation of the image information contained in the main section 38 of the image 36 takes place in a manner known in the art according to the core function of the optical module and is not described in more detail here. Evaluation of the projection 42 of the detection region 20 located in the auxiliary section 40 serves to determine the rain intensity in order to be able to control a windscreen wiper, also referred to as a windshield wiper.

For this purpose, in the projection 42 of the detection region 20 is defined an evaluation region 46 which is divided into several partial regions 48. The partial regions 48 are tested for their average brightness in order to detect any disturbing light spots present which may be caused by headlamps, street lighting and/or tunnel lighting and falsify further image evaluation. In case of detection of a disturbing light spot of this kind, the respective partial region 48 in which the light spot is detected is ignored during further image evaluation, and so to a certain extent deactivated.

Then edge image calculation is carried out in the remaining partial regions 48, for example by means of the Sobel operator. The edges of an object located on the windscreen 16 ascertained in this manner, e.g. water drop edges, are then segmented, segmentation preferably being carried out with an adaptive threshold value.

The segmented picture elements obtained in this way are then added up, i.e. the number of segmented picture elements is determined.

The sum or number of segmented picture elements finally forms a measure of the total length of the edges of all objects detected in the partial regions 48 of the evaluation region 46 that are taken into account, and therefore a measure of the density of water drops in the detection region 20 of the windscreen 16. In this way the rain intensity can be determined from the sum of segmented picture elements.

The image evaluation unit is connected to a windscreen wiper control system (also referred to as a windshield wiper control system), not shown, which controls the operation of a windscreen wiper, for example for the windscreen 16, as a function of the rain intensity determined, and in particular variably sets the wiping interval, i.e. the interval between two wiping operations. Alternatively, the windscreen wiper control system may, instead of continuous adjustment of the wiping interval, also select fixed modes of the windscreen wiper such as for example single wiping, continuous wiping and rapid continuous wiping.

In order to be able to distinguish raindrops or snowflakes from other objects, so-called disturbing objects, a projection 42 of the detection region 20 recorded immediately after passage of the windscreen wiper through the detection region 20 is evaluated. Assuming that no water drops or snowflakes are in the detection region 20 immediately after passage of the windscreen wiper through the detection region 20, all edges detected at this time are due to disturbing objects, i.e. to soiling in the detection region 20 of the windscreen 16 such as e.g. insects or scratches, or to foreign bodies on the lens 24 or on the mirror 26 such as e.g. dust.

The detected disturbing objects are counted out during evaluation of a subsequently recorded image, i.e. the sum of segmented picture elements resulting from the disturbing objects is deducted from the sum total of segmented picture elements. In this way a rain intensity which is higher than the actually prevailing rain intensity is prevented from being accidentally determined due to the disturbing objects. Lastly, by this means faulty actuation of the windscreen wiper or unnecessarily fast actuation of the windscreen wiper is avoided.

In order to be able to take into consideration the appearance of new disturbing objects or the removal of already detected disturbing objects, the detection of disturbing objects is preferably carried out after each passage of the windscreen wiper through the detection region 20.

1. An optical module for a vehicle having a windshield that includes a detection region, comprising
a camera arranged at an inner side of the windshield and having a field of vision directed through the windshield toward an ambient region about the vehicle, said camera comprising a sensor having a sensor surface that includes a first section and a second section, and an objective arranged with the sensor surface for focusing a distant region on the first section to create a sharp image, and
an optical assembly disposed in the field of vision and adapted for focusing the detection region on the second section to create a sharp image.

2. An optical module according to claim 1, wherein the optical assembly comprises a lens disposed between the windshield and the objective.

3. An optical module according to claim 2, wherein the optical assembly further comprises a mirror for guiding light from the detection region through the lens to the camera.

4. An optical module according to claim 3, wherein the optical assembly further comprises a screen for shielding light deflected by the mirror from impinging on the first section of the sensor surface.

5. An optical module according to claim 1 further comprising a light source adapted for illumination of the detection region.

6. An optical module according to claim 5, wherein the light source comprises a light-emitting diode adapted to emit light in the infrared wavelength range.

7. An optical module according to claim 5 wherein the light source radiates light in a preferential direction to impinges on an outer side of the windshield at an angle not equal to 90°.

8. An optical module according to claim 7, wherein the preferential direction forms an angle within the range from approximately 10° to 30° with the inner side.

9. An optical module according to claim 5, wherein the optical assembly further comprises a mirror for guiding light from the detection region to the camera, wherein the mirror is disposed between the light source and the camera.

10. An optical module according to claim 9, wherein the mirror is impermeable to light from the light source.

11. An optical module according to claim 1, wherein the camera is adapted to be coupled to an image evaluation unit configured for detecting an object in an image recorded by the second section by edge extraction.

12. An optical module according to claim 11, wherein the image evaluation unit is coupled to a windshield wiper control system for a windshield wiper and having a wiping interval based upon object detection.

13. A method for controlling a wiping interval of a windshield wiper of a motor vehicle, said method comprising
providing an optical module comprising
a camera arranged at an inner side of the windshield and having a field of vision directed through the windshield toward an ambient region about the vehicle, said camera comprising a sensor having a sensor surface that includes a first section and a second section, and an objective arranged with the sensor surface for focusing a distant region on the first section to create a sharp image, and
an optical assembly disposed in the field of vision and adapted for focusing the detection region on the second section to create a sharp image;
detecting an object in an image recorded by the second section; and
determining the wiping interval based upon detection of the object.

14. A method according to claim 13, wherein detecting the object comprises performing edge extraction on the image.

15. A method according to claim 14, wherein performing edge extraction includes extracting an edge of the object and segmenting the edge by using an adaptive threshold value.

16. A method according to claim 15, wherein segmenting the edge adding picture elements of the edge to obtain a sum and determining a rain intensity based upon the sum.

17. A method according to claim 13, further comprising recording an image immediately after passage of a wiper blade through the detection region, and classifying an object detected therein as a disturbing object.

18. A method according to claim 17, further comprising ignoring the disturbing object when detecting an object in a subsequently recorded.

19. A method according to claim 13, further comprising dividing the image recorded by the second section into a plurality of partial regions, determining if a partial region exhibits a significantly higher brightness, and deactivating the partial region when detecting an object.
